(19) United States
(12) Patent Application Publication
(10) Pub. No.: US 2008/0304901 A1
(43) Pub. Date: Dec. 11, 2008

(54) Duplex ring binder

(76) Inventor: Richard M. Seman, Pittsburgh, PA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 12/156,693

(22) Filed: Jun. 4, 2008

Related U.S. Application Data
(60) Provisional application No. 60/933,392, filed on Jun. 6, 2007.

(51) Int. Cl. B42F 13/00; B42F 13/20; B42F 3/04

(52) U.S. Cl. 402/74; 281/45; 402/70; 281/29

(57) ABSTRACT

A duplex binder assembly is provided that is comprised of two oppositely facing binders that share a common back cover. In this way, a symmetry is created which is lacking in known designs, which promotes more complimentary vertical storage with typical companion materials such as books.

### CROSS REFERENCE TO RELATED APPLICATIONS

The present application claims the benefit of U.S. Application Ser. No. 60/933,392, entitled “Duplex Ring Binder”, filed Jun. 6, 2007, the entirety of which is incorporated by reference.

### BACKGROUND

1. Field of the Disclosure

The present disclosure generally relates to binders and more particularly to an improved ring binder that permits the orderly storage of the binders when not in use and maximizes shelf space during storage.

2. Brief Description of Related Art

Loose leaf documents and items are often stored in a ring or other type of binder. As opposed to other methods of keeping documents organized for transport or storage, the ring binder offers ease of insertion and removal while keeping the documents securely fastened. The most common type of ring binder, as seen in FIG. 1, is the three-ring binder 10.

In general, three-ring binders have a ring base 20 that holds the rings 30 (only one is partially shown) in a fixed row relative to one other (not shown), the ring base being mounted on a spinal cover 40. This spinal cover 40 is also rotatably connected to a front cover 50 and a rear cover 60 that is usually made of a material that is stiffer than the intended contents. In an alternative embodiment (not shown), the ring base 20 may be attached to the rear cover 60 at a location adjacent to the spinal cover 40. Either embodiment results in a triangular shape as seen from a bottom or top end of the binder, which results in unfavorable storage geometry. When a closed binder of the current art is placed flat on a desk with a text book or other book on top of it, the text book or other book will typically slide off of the binder and, often, onto the floor. As shown in FIG. 2, when more than one closed binders 10 of the prior art are placed on a book shelf 70 due to their asymmetrical shape, the binders 10 do not stack neatly together. When a closed binder 10 of the current art is placed on a book shelf 70 next to other closed binders 10, it often happens that pulling one binder 10 off the shelf 70 causes other binders 10 to shift in position due to their asymmetrical shape when the binders 10 are not completely full.

In light of this prior art, it is desirable to provide a binder that has a generally rectangular shape as seen from a bottom end or a top end of the binder. This and other developments are a result of the present disclosure.

### SUMMARY OF THE INVENTION

There remains a long-felt need for a relatively compact binder that is capable of being non-slidably stacked with other binders and can be stored on a shelf adjacent to other binders in a visually appealing and orderly way.

In accordance with the present invention, a duplex binder assembly is provided that is comprised of two oppositely facing binders that share a common back cover. In this way, a symmetry is created which is lacking in known designs, which promotes more complimentary vertical storage with typical companion materials such as books.

In another embodiment, a single duplex binder can store and distinguish between two different classifications of stored material. Multi-colored vinyl materials typical of manufactured binders can further help to distinguish content.

Another aspect of storage utility is that of volume. A given amount of material can be stored in a much smaller area for an up to 50% savings in space. A horizontal storage advantage also occurs when stacking multiple duplex binders or a single duplex binder in combination with other rectangular materials such as books. These storage advantages begin with merchandising the item on a retailer's shelves and run throughout the life of the product by the consumer.

Additionally, the present invention provides for a binder comprising: a first cover having a first surface and a second surface generally opposite the first surface, a top edge, a bottom edge, a first side edge and a second side edge; a first spine portion having a first surface, a second surface generally opposite the first surface, a top edge, a bottom edge, a first side edge and a second side edge, wherein the first side edge is directly or indirectly pivotally coupled to a side edge of the first cover; a first binder mechanism mounted on the first surface of the first spine; an intermediary cover having a first surface and a second surface generally opposite the first surface, a top edge, a bottom edge, a first side edge and a second side edge, wherein the first side edge is directly or indirectly pivotally coupled to the second side edge of the first spine portion; a second spine portion having a first surface, a second surface generally opposite the first surface, a top edge, a bottom edge, a first side edge and a second side edge, wherein the first side edge is directly or indirectly pivotally coupled to the second side edge of the intermediary cover; a second binder mechanism mounted on the second surface of the second spine; a second cover having a first surface, a second surface generally opposite the first surface, a top edge, a bottom edge, a first side edge and a second side edge, wherein a side edge of the second cover is directly or indirectly pivotally coupled to the second side edge of the second spine portion.

Further, the present invention provides for a binder comprising: a first cover having a first surface and a second surface generally opposite the first surface; at least two spine portions having a first surface and a second surface generally opposite the first surface; at least two binder mechanisms, wherein one of the at least two binder mechanisms is mounted on a first surface of one of at least two spine portions and another of the at least two binder mechanisms is mounted on a second surface of another of at least two spine portions; at least one intermediary cover having a first surface and a second surface generally opposite said first surface, and a second cover having a first surface and a second surface generally opposite said first surface; wherein one of the at least two spine portions is pivotally coupled to the first cover and an intermediary cover and the other of the at least two spine portions is pivotally coupled to the second cover and an intermediary cover.

### BRIEF DESCRIPTION OF THE DRAWINGS

For the present disclosure to be easily understood and readily practiced, the present disclosure will now be described for purposes of illustration and not limitation in connection with the following figures, wherein:

FIG. 1 is a perspective view of the known prior art ring binder;

FIG. 2 is a perspective view of a shelf holding a number of known prior art ring binders (as shown in FIG. 1) stacked next to one another;

FIG. 3 is a top perspective view of a preferred embodiment of the present invention illustrating the binder completely closed;

FIG. 4A is a perspective view of the binder shown in FIG. 3 illustrating the binder partially opened;

FIG. 4B is a top elevation view of the binder shown in FIG. 3 illustrating the binder completely opened;

FIG. 5 is a perspective view showing two binders shown in FIG. 3 stacked on top of one another and with books.

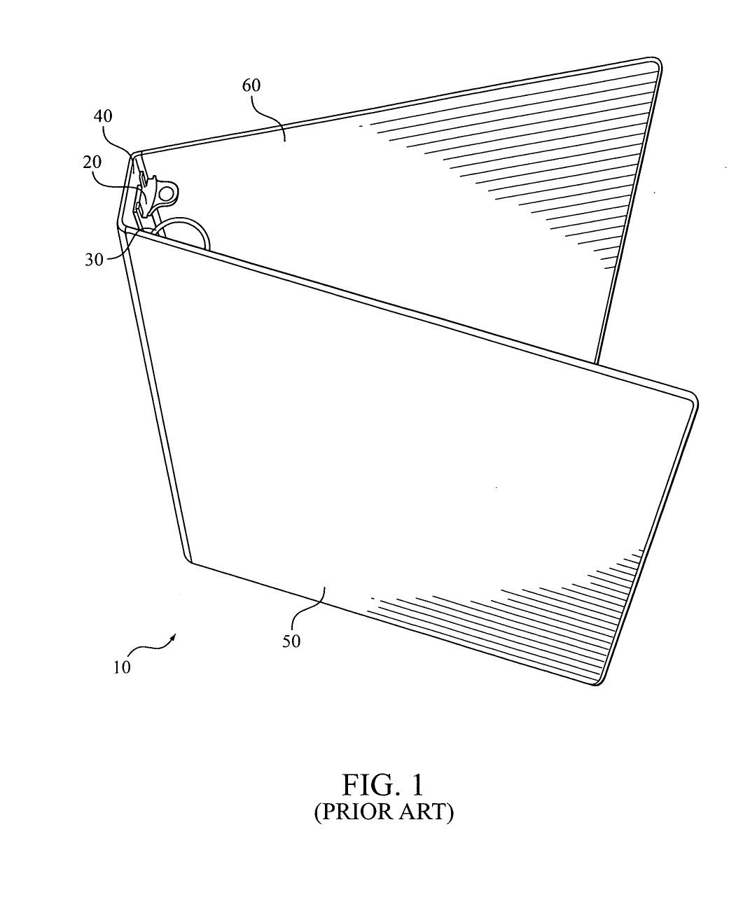

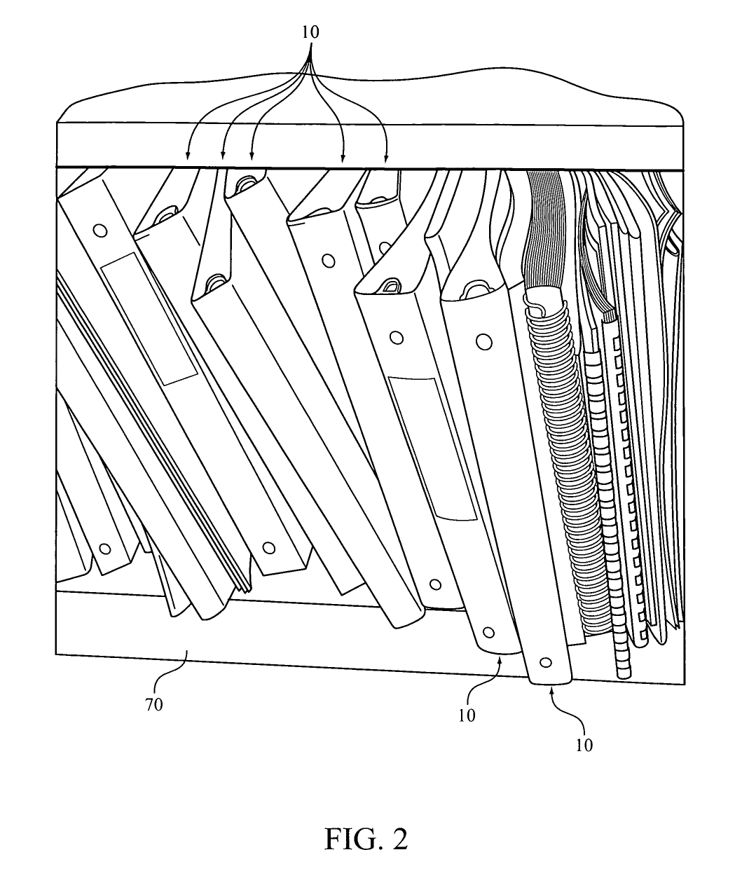

### DETAILED DESCRIPTION OF THE DRAWINGS

In the following detailed description, reference is made to the accompanying examples and figures that form a part hereof, and in which is shown, by way of illustration, specific embodiments in which the inventive subject matter may be practiced. These embodiments are described in sufficient detail to enable those skilled in the art to practice them, and it is to be understood that other embodiments may be utilized and that structural or logical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

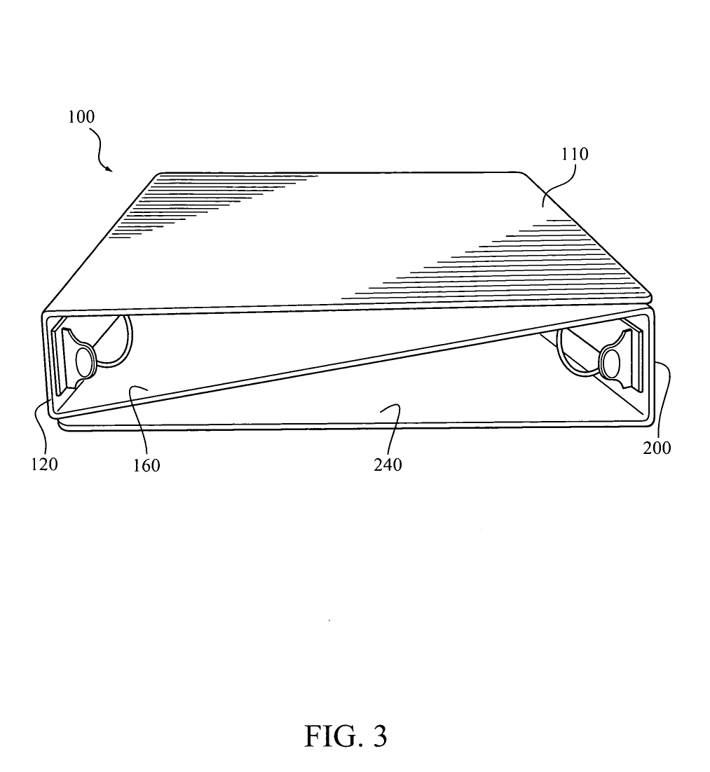

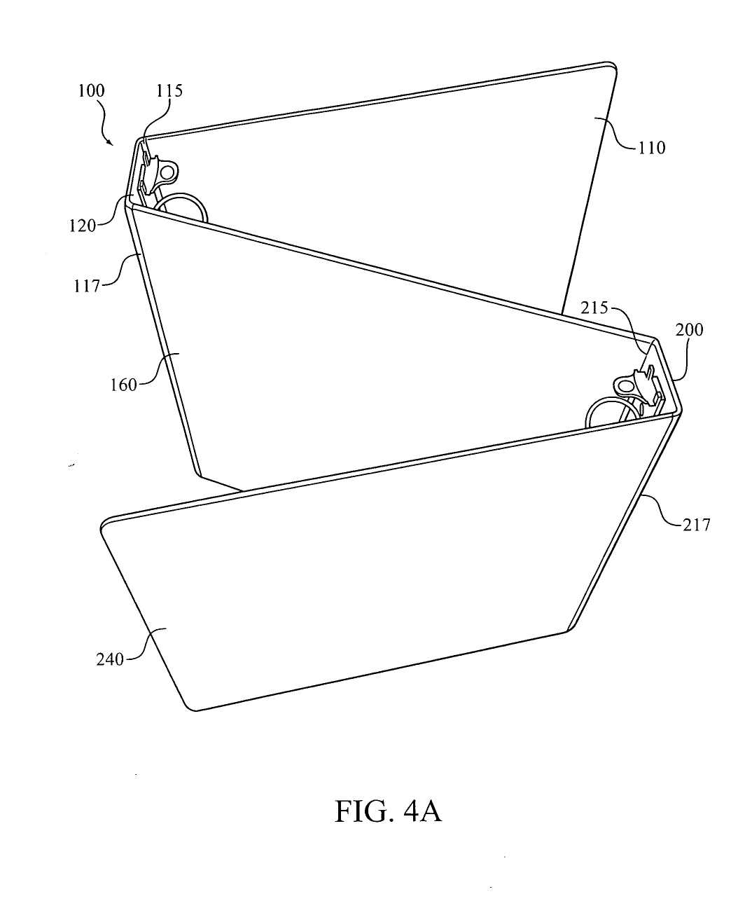

As shown in FIG. 3, the binder of the present invention, generally designated 100, may include first cover 110, first spine portion 120, intermediary cover 160, second spine portion 200 and second cover 240. Binder 100 may be movable between a closed position as shown in FIG. 3 and an open position (FIG. 4B). When binder 100 is in the closed position, first cover 110, first spine portion 120 and intermediary cover 160 define a holding space that is triangular in shape when viewed from the top. Similarly, second cover 240, second spine portion 200 and intermediary cover 160 define a holding space that is triangular in shape when viewed from the top. Additionally, first cover 110, first spine portion 120, second spine portion 200 and second cover 240 form a generally rectangular shape when viewed from the top.

In a preferred embodiment, each of first cover 110, intermediary cover 160, second cover 240, first spine portion 120 and second spine portion 200, may be generally planar, rectangular in shape, and comprised of rigid material so as to reduce bending or deformation of shape.

As shown in FIG. 4A, first cover 110 may be pivotably coupled to first spine portion 120 by flexible connector 115. Likewise, second cover 240 may be pivotably coupled to second spine portion 200 by flexible connector 217. Intermediary cover 160 may be pivotably coupled on one side to first spine portion 120 by flexible connector 117 and on an opposite side to second spine portion 200 by flexible connector 215.

As shown in FIG. 4B, first cover 110, first spine portion 120, intermediary cover 160, second spine portion 200 and second cover 240 each have a first surface 112, 122, 162, 202 and 242, respectively, and a second surface 114, 124, 164, 204 and 244, respectively. First surfaces 112, 122, 162, 202 and 242 being generally opposite second surfaces 114, 124, 164, 204 and 244. First binder mechanism 130 may be fixably attached to first surface 112 of first spinal panel 120. First binder mechanism 130 may connectably hold a first set of rings (not shown). Second binder mechanism 230 may be fixably attached to second surface 204 of second spinal panel 200. Second binder mechanism 230 may connectably hold a second set of rings (not shown). As previously discussed, first surface 112 of first spinal panel 120 is generally opposite second surface 204 of second spinal panel 200.

Configured in this manner, when binder 100 is in the closed position, binder 100 resembles two oppositely facing binders that share a common back cover. Binder 100 may store and distinguish between two different classifications of stored material. Additionally, first cover 110, intermediary cover 160 and second cover 240 may be comprised of different colors to further help to distinguish the content held by first binder mechanism 130 and second binder mechanism 230.

First and second binder mechanisms, 130, 230, respectively, may be used to releaseably engage articles to be held within binder 100. First and second binder mechanisms, 130, 230, respectively, may be a three-ring snap, slide, screw or lever binder. Additionally, more or fewer than three rings may be used. Further, instead of or in addition to a first set of rings, first and second binder mechanisms, 130, 230, respectively, may hold clamps, clips and other mechanisms for holding materials within binder 100. Additionally, binder mechanisms 130, 230, may be coil or spring binding. Binder mechanisms 130, 230 is not limited to what is particularly disclosed but can also be nearly any mechanism for binding a plurality of articles together.

In another embodiment (not shown), either first cover 110 or second cover 240, or both, may be converted into intermediary covers 160 by pivotably coupling the covers to additional spine portions via flexible connectors. In these embodiments, four or more triangular-shaped holding spaces are created and connected together in a symmetrical package. While any number of binders may be connected in this fashion, it is preferable to have an even number in order to maintain the symmetrical shape.

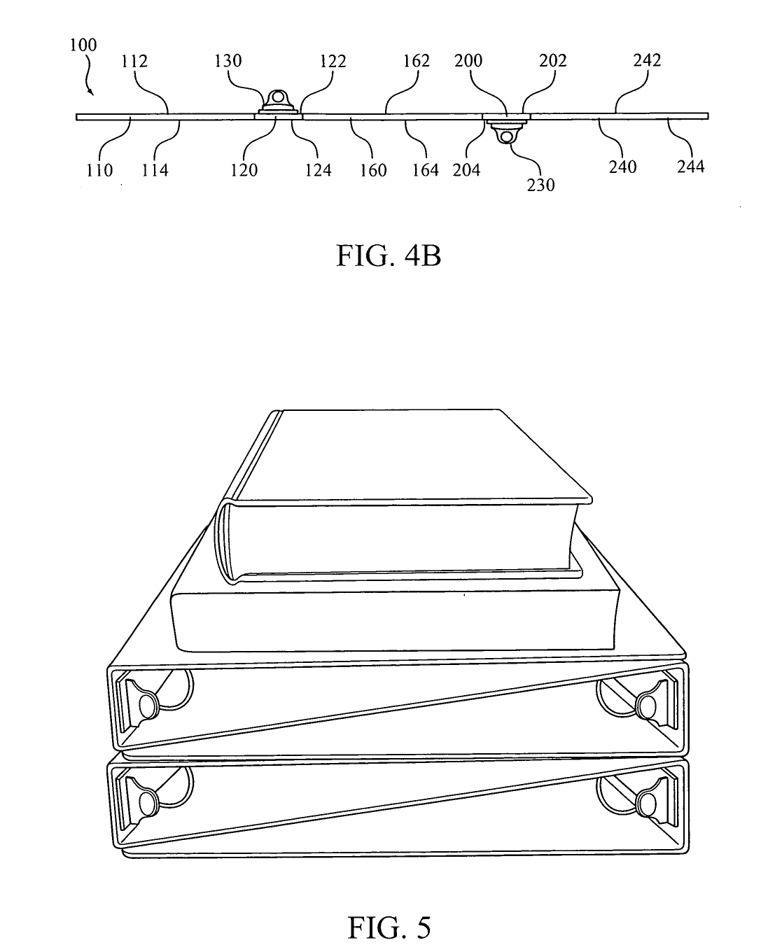

As shown in FIG. 5, when a closed binder of the present invention is placed flat on a desk with a text book or other book on top of it, the text book or other book will stack neatly on top of the present invention.

All of the references cited herein are incorporated by reference in their entirety.

It is emphasized that the Abstract is provided to comply with 37 CFR §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A binder comprising:
a first cover having a first surface and a second surface generally opposite said first surface, a top edge, a bottom edge, a first side edge and a second side edge;
a first spine portion having a first surface, a second surface generally opposite said first surface, a top edge, a bottom edge, a first side edge and a second side edge, wherein said first side edge is directly or indirectly pivotally coupled to a side edge of said first cover;
a first binder mechanism mounted on said first surface of said first spine;
an intermediary cover having a first surface and a second surface generally opposite said first surface, a top edge, a bottom edge, a first side edge and a second side edge, wherein said first side edge is directly or indirectly pivotally coupled to said second side edge of said first spine portion;
a second spine portion having a first surface, a second surface generally opposite said first surface, a top edge, a bottom edge, a first side edge and a second side edge, wherein said first side edge is directly or indirectly pivotally coupled to said second side edge of said intermediary cover;
a second binder mechanism mounted on said second surface of said second spine;
a second cover having a first surface, a second surface generally opposite said first surface, a top edge, a bottom edge, a first side edge and a second side edge, wherein a side edge of said second cover is directly or indirectly pivotally coupled to said second side edge of said second spine portion.

2. The binder of claim 1 wherein said first binder mechanism and said second binder mechanisms are ring assemblies.

3. The binder of claim 1 wherein said covers and spine portions are comprised of plastic.

4. The binder of claim 1 additionally comprising at least one closure mechanism for retaining said binder in a closed position.

5. A duplex binder assembly comprised of two oppositely facing binders that share a common back cover.

6. The duplex binder assembly of claim 5 additionally comprising at least two binder mechanisms.

7. The duplex binder assembly of claim 5 wherein said duplex binder assembly is comprised of plastic.

8. The duplex binder assembly of claim 5 additionally comprising at least one closure mechanism for retaining said binder in a closed position.

9. A binder comprising:
a first cover having a first surface and a second surface generally opposite said first surface;
at least two spine portions having a first surface and a second surface generally opposite said first surface;
at least two binder mechanisms, wherein one of said at least two binder mechanisms is mounted on a first surface of one of at least two spine portions and another of said at least two binder mechanisms is mounted on a second surface of another of at least two spine portions;
at least one intermediary cover having a first surface and a second surface generally opposite said first surface, and
a second cover having a first surface and a second surface generally opposite said first surface;
wherein one of said at least two spine portions is pivotally coupled to said first cover and an intermediary cover and the other of said at least two spine portions is pivotally coupled to said second cover and an intermediary cover.

10. The binder of claim 9 wherein said at least two binder mechanisms are ring assemblies.

11. The binder of claim 9 wherein said covers and spine portions are comprised of plastic.

12. The binder of claim 9 additionally comprising at least one closure mechanism for retaining said binder in a closed position.
